(19) United States
(12) Patent Application Publication
(10) Pub. No.: US 2016/0134036 A1
(43) Pub. Date: May 12, 2016

(54) SIGNAL INTEGRITY IN MUTLI-JUNCTION TOPOLOGIES

(71) Applicant: Intel Corporation, Santa Clara, CA (US)

(72) Inventors: Shaowu HUANG, Seattle, WA (US); Ifiok J. UMOH, Olympia, WA (US); Kai XIAO, University Place, WA (US); Beom-Taek LEE, Mountain View, CA (US)

(21) Appl. No.: 14/539,597

(22) Filed: Nov. 12, 2014

(51) Int. Cl. H01R 12/70

(52) U.S. Cl. CPC H01R 12/7076

(57) ABSTRACT

A channel (e.g., memory channel) coupling a processor to multiple devices (e.g., DIMMs) is described. The channel has an interconnect topology with multiple interconnect portions coupled together with two or more junctions. At least one of these junctions has first and second interconnect portions that cross each other to form a plus-shaped junction. Also, the interconnect routing between the two or more junctions has an impedance matched to impedance of the two or more junctions.

### FIELD OF THE INVENTION

This disclosure pertains to computing system, and in particular (but not exclusively) to a computing system having a channel with a daisy-chain type interconnect topology having junctions limited by reflection resonances.

### BACKGROUND OF THE INVENTION

In computing systems, when using a channel for high speed signaling and the channel comprises multiple slots or nodes in a daisy-chain interconnect topology, there exists a junction effect in which noise signals are created by multiple reflections. For instance, in a typical daisy-chain interconnect topology with two or more junctions per channel, multiple reflections between junctions are significant, and seriously degrades channel signaling performance.

Current state of the art avoid this problem by running memory channels at slower speeds and/or improving the electrical performance of components in the channel to compensate for the junction effects and/or reducing the number of slots or nodes per channel depending on the signal integrity requirement so the system.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1A illustrates one embodiment of an apparatus with a channel (e.g., a memory channel) that includes an interconnect topology that has two junctions.

FIG. 1B illustrates another embodiment of an apparatus with a channel (e.g., a memory channel) that includes an interconnect topology that has two junctions.

FIG. 2 illustrates one embodiment of a junction to junction interconnect routing length in a channel (e.g., a memory channel).

FIG. 3 illustrates one embodiment of a topology with a junction to junction interconnect routing width increased.

FIG. 4 illustrates one embodiment of a “+” topology (i.e., a plus-shaped topology).

FIGS. 5-7 show different embodiments three different locations of the “+” junction in a computing system.

FIG. 8 illustrates another interconnect topology.

FIG. 9 illustrates one embodiment of a hybrid T topology with staggered transition vias.

FIG. 10 is another alternative embodiment of an interconnect topology.

FIG. 11 illustrates one embodiment of the staggered via configuration.

FIG. 12 illustrates the lengths for the interconnect portions of the interconnect topology shown in FIG. 10 according to one embodiment.

FIG. 13 is a dataflow diagram of one embodiment of a process for employing an interconnect topology described herein.

FIG. 14 illustrates an embodiment of a block diagram for a computing system.

### DETAILED DESCRIPTION

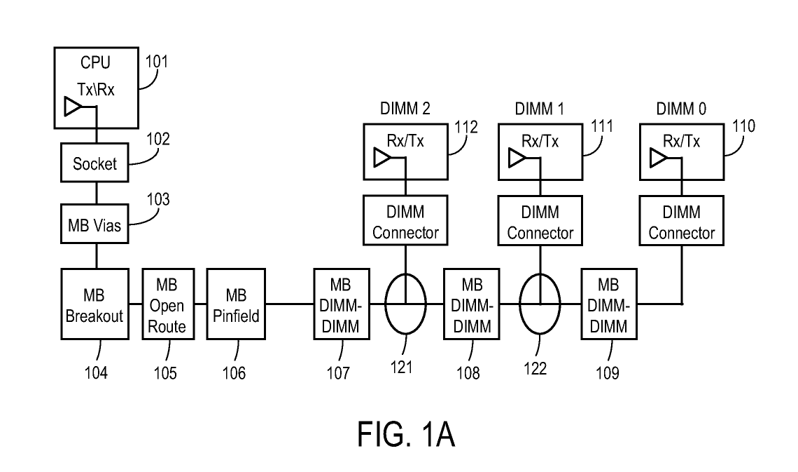

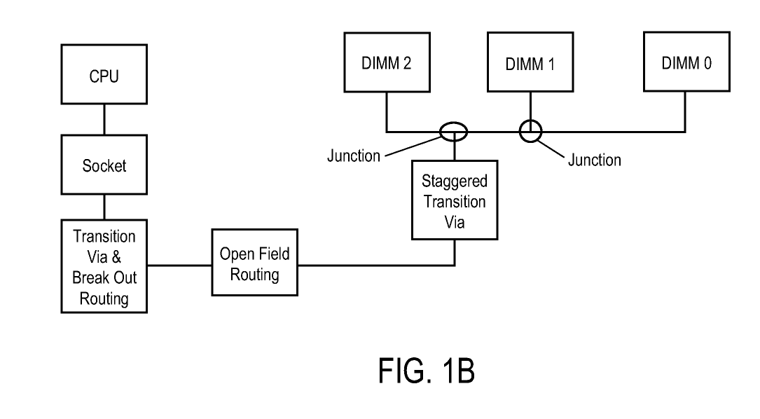

FIG. 1A illustrates an apparatus with a channel (e.g., a memory channel) that includes an interconnect topology that has two junctions. The number of junctions depends on the number of slots. Referring to FIG. 1A, the channel configuration has 2 slots and, therefore, three slots. The techniques described herein may be applied to channel configurations with three or more junctions. In another embodiment, the channel configuration has 4 slots and three junctions. In one embodiment, the channel is a double data rate (DDR) memory channel with multiple dual in-line memory modules (DIMMs) (e.g., a 3 slot per channel configuration). In one embodiment, the interconnect topology substantially reduces the junction effect of the multiple slots or nodes in a channel for high speed signaling (e.g., 2.5 GHz), such as, for example, but not limited to, suppressing the effect of the junctions in DDR memory channel with multiple DIMMs.

In one embodiment, the reflected noise signals of junctions are eliminated by eliminating the multiple reflections between junctions, particularly for memory channels, which in turn eliminates the reflection resonances between junctions. This reduces inter-symbol interference (ISI) and harmful coupling and corrects timing jitter, both of which are induced by the junctions reflected signals.

In one embodiment, in order to eliminate the multiple reflections between junctions, three techniques are used, including (1) reducing the routing length of interconnect routing between junctions, which pushes the resonance frequency higher, thus helping mitigate junctions effects; (2) matching the impedance of interconnect routing between junctions to the impedance of the junctions, which reduces the impedance discontinuities and thus suppresses the junction resonance effects; and (3) changing a two junctions topology to a single junction topology, which reduces, and potentially eliminates, the multiple reflections between junctions.

Referring to FIG. 1A, one embodiment of an apparatus having a 3 slots per channel configuration (the number of physical DIMM slots designed for the channel) is shown with a CPU (CPU 101) and three DIMMs, namely DIMM0, DIMM1 and DIMM2. This configuration is used in DDR memory. CPU 101 is connected to a motherboard (MB) via a socket 102. Socket 102 is connected to signal traces in the motherboard through MB vias 103. MB breakout 104 represents the signal trace interface between MB vias 103 and MB open route 105, which are the signal traces in the MB itself. The signal traces of MB open route 105 emerge at MB pinfield 106, which represents an external interface of the MB. Each of MB DIMM-DIMM 107-108 is an interconnect portion of the memory channel (i.e., a portion of an interconnect topology of a memory channel), including their associated signal traces, for connecting DIMM cards to traces in the MB.

MB DIMM-DIMM 107 and MB DIMM-DIMM 108 are connected together with an interconnect portion of the memory channel that includes junction 121, while MB DIMM-DIMM 108 and MB DIMM-DIMM 109 are connected together with an interconnect potion of the memory channel that includes junction 122. Each of DIMM cards 110-112 includes a memory and a DIMM connector to interface to the interconnect portions of the memory channel. Thus, junction 121 includes the port to DIMM2, and junction 122 includes the port to DIMM1.

Junctions 121 and 122 are 3-port junctions. For a 3-port junction, the input impedance of one port can be expressed as

$${Z}_{junction} = \frac{{Z}_{1} {Z}_{2}}{{Z}_{1} + {Z}_{2}} \qquad ( 1 )$$

where Z₁ and Z₂ are the output impedances of the other two ports. Given Z₁≅Z₂, Z_{junction}≅0.5Z₁. This means that, the junction impedance is only half of the characterization impedance of regular routings in the channel. Thus, the impedance discontinuities due to junctions are usually much larger if compared with other discontinuities in the channel. In the case of DDR, this results in the degradation of DDR signal integrity, which is due to the multiple reflection resonances caused by the junctions.

In order to improve the signaling performance (e.g., the DDR signaling performance), techniques described herein substantially reduce, or potentially eliminate, the multiple reflections between these junctions. Specifically, in one embodiment, three techniques are used to suppress the junction reflection resonance and reduce the multiple reflections.

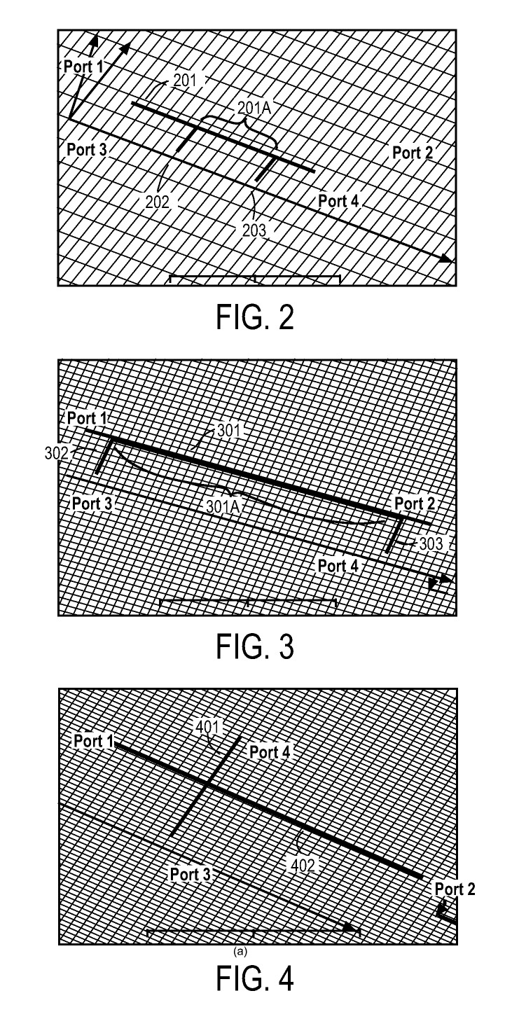

The first of the three techniques involves reducing the interconnect length between two junctions. FIG. 2 illustrates one embodiment of a junction to junction interconnect routing length in a channel (e.g., a memory channel). Referring to FIG. 2, the junction to junction interconnect includes interconnect portions 201-203, with ports 1 and 2 being at the ends of interconnect portion 201. Ports 3 and 4 are at the ends of interconnect portions 202 and 203, respectively, which are connected in a perpendicular arrangement with interconnect portion 201. In one embodiment, the junctions of interconnect portions 202 and 203 with interconnect portion 201 represent junctions 121 and 122 of FIG. 1A.

In FIG. 2, the length of the part 201A of interconnect portion 201 is reduced in comparison to the length of an original interconnect between the two junctions. More specifically, the first resonance frequency of the junction-to-junction interconnect can be written as

$${f}_{resonance} \approx \frac{c}{2 L \sqrt{{ɛ}_{eff}}} \qquad ( 2 )$$

where c is the speed of electromagnetic wave in vacuum (free space), ∈_{eff} is the effective relative permittivity of the interconnect medium, and L is the length of the interconnect routing. Based on equation (2), the resonance frequency can be pushed onto higher frequency by increasing the routing length L, which can improve the signaling performance. In addition, it also can reduce the crosstalk a little bid. In one embodiment, the topology with a junction to junction interconnect routing length is reduced to 0.15 in. from 0.7 in. In such a case, the resonance frequency has been pushed out to 10 GHz.

Various other routing lengths include, but are not limited to, 0.8 in., 0.6 in., 0.4 in, and 0.3 in., while the routing width is 4 or 6 mils. Note that other lengths and width may be used and select to reduce reflections at either or both of the junctions.

The second of the three techniques involves matching the routing impedance of the interconnect with the junction impedance. Since junctions have much smaller impedance than the regular routing, the interconnect impedance can be chosen to match that of the two junctions, so that the reflections between two junctions are substantially reduced, and potentially eliminated. More specifically, as showed in formula (3) below, the impedance of routing are approximately proportional to dielectric high h, and are approximately inverse proportional to the routing width w and the dielectric constant ∈.

$${Z}_{Tline} ∼ \frac{1}{w} , h , \frac{1}{ɛ} \qquad ( 3 )$$

Thus, the impedance can be matched by one or more of the following three ways: increasing the routing width; reducing the routing dielectric thickness; or increasing routing dielectric constant. Note that increasing routing width several mils gives a small amount of additional crosstalk in DDR channel implementations when compared to interconnect routings that are thinner, but it is negligible compared to the overall crosstalk in the DDR channel because there are some components including the DIMM connectors dominate the channel crosstalk, which are typically more than 10 dB higher than the crosstalk of junction to junction interconnect routing. Note, in one embodiment, the benefits are increased, and potentially maximized, based on selection of the routing width.

FIG. 3 illustrates one embodiment of a topology with a junction to junction interconnect routing width increased to 15 mils from 4 mils (an original width). Referring to FIG. 3, the junction to junction interconnect routing includes interconnect portions 301-303, with ports 1 and 2 being at the ends of interconnect portion 301. Ports 3 and 4 are at the ends of interconnect portions 302 and 303, respectively, which are connected in a perpendicular arrangement with interconnect portion 301. In one embodiment, the junctions of interconnect portions 302 and 303 with interconnect portion 201 represent junctions 121 and 122 of FIG. 1A.

In FIG. 3, part 301A of interconnect portion 301 has a junction to junction interconnect routing width increased from 4 mils to 15 mils. This causes a dampening of resonance amplitudes.

The third of the three techniques involves changing from a traditional topology with 2 junctions to a new “+” topology with 1 junction. FIG. 4 illustrates one embodiment of a “+” topology (i.e., a plus-shaped topology). Referring to FIG. 4, interconnect portion 401 (with ports 3 and 4 at different ends) is connected to and crosses interconnect portion 402 (with ports 1 and 2 at different ends). In one embodiment, the interconnect portion 401 and 402 are substantially perpendicular to each other. Although in one embodiment there is still a 4-port junction in the channel, the reflection from the junction is absorbed by the on-die termination in the DIMMs. In one embodiment, the “+” topology is used for computing systems with 3 or more DIMMs per channel.

Note that there is no limitation in the location of the “+” junction in the channel, but the empty connector effect need to be handled appropriately.

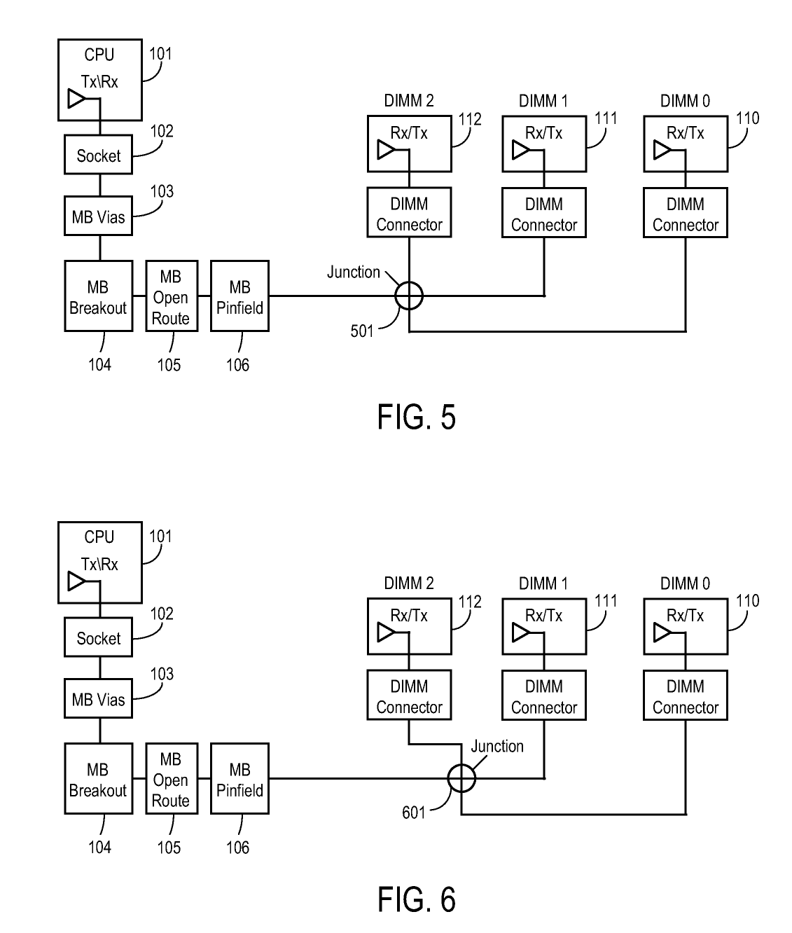

FIGS. 5-7 show different embodiments three different locations of the “+” junction in a computing system. In FIG. 5, the “+” junction 501 is located at DIMM2. In such a case, one of the interconnect portions of the junction 501 is perpendicular to the other interconnect portion of junction 501 and extends directly to DIMM2.

In FIG. 6, the “+” junction 601 is located between DIMM2 and DIMM1. In one embodiment, the distance between DIMM1 and DIMM2 is 500 mils.

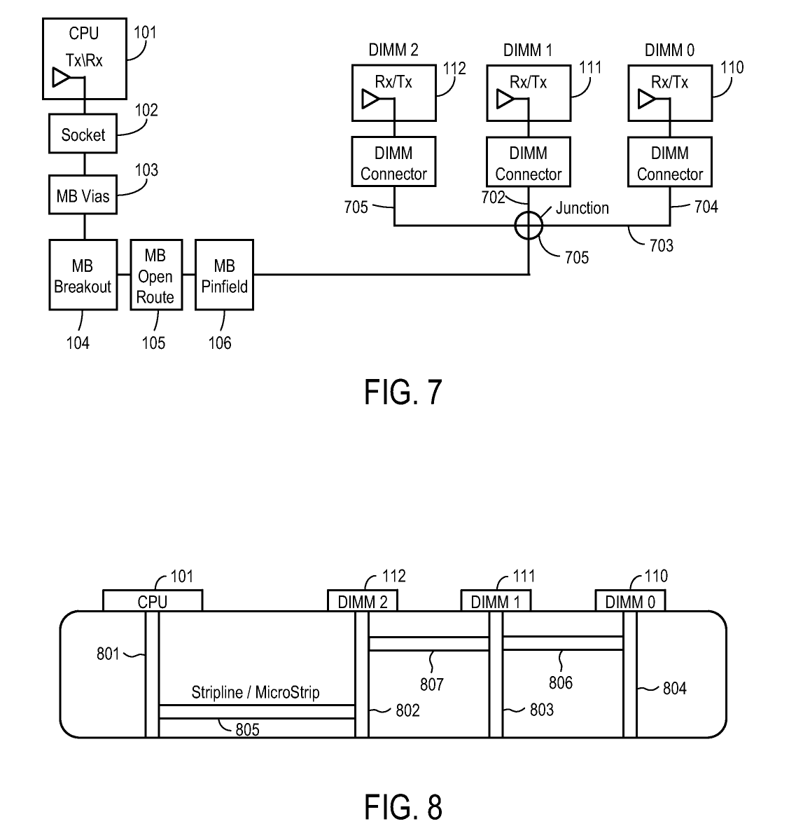

In FIG. 7, the “+” junction 701 is located at DIMM1. In such a case, one of the interconnect portions, interconnect portion 702, of the junction 501 is perpendicular to the other interconnect portion 703 of junction 501 and extends directly to DIMM1, and interconnect portion 703 extends to interconnect portions 704 and 705, which are substantially at right angles to interconnect portion 703 and extend directly to DIMM0 and DIMM 1, respectively.

Table 2 illustrates a comparison of the routing lengths of the four different “+” junction topologies in FIG. 5-7 and a 2-junction topology. Note that l₀ refers to the end to end routing length from DIMM0 to CPU, l₁ refers to the end to end routing length from DIMM1 to CPU, l₂ refers to the end to end routing length from DIMM2 to CPU, ΔL_{DD} refers to the minimum routing length between DIMM2 to DIMM1, and ΔL_{C,D2} refers to the minimum routing length between CPU to DIMM2. To simplify the comparison, it is assumed that the spacing between DIMM2 and DIMM1 is same as the spacing between DIMM1 and DIMM0. In the 2-junction topology, the longest routing length is to DIMM0 with l₀=ΔL_{C,D2}+2ΔL_{DD}. For the three “+” topologies, the longest routing length is also to DIMM0 with l₀=ΔL_{C,D2}+2ΔL_{DD}. This indicates that the “+” topologies do not increase the maximum end to end routing lengths in memory channels with three DIMMs. Furthermore, the use of the “+” topologies described herein does not increase the maximum end to end crosstalk for CPU to DIMM2/DIMM1/DIMM0 as well as channel loss.

TABLE 2
Comparison of routing lengths: three topologies with different locations
of “+” junction of FIGS. 5-7 and a 2-junction topology.

| | | | FIG. 6 | |
|---|---|---|---|---|
| Routing | | FIG. 5 | between DIMM2 | FIG. 7 |
| lengths | Original | at DIMM2 | and DIMM1 | at DIMM1 |
| CPU to | l₂ = ΔL_{C, D2} | l₂ = ΔL_{C, D2} | ΔL_{C, D2} + 2ΔL_{DD} > | l₂ = ΔL_{C, D2} + |
| DIMM2 | | | l₂ > ΔL_{C, D2} | 2ΔL_{DD} |
| l₂ | | | | |
| CPU to | l₁ = ΔL_{C, D2} + | l₁ = ΔL_{C, D2} + | l₁ = ΔL_{C, D2} + | l₁ = ΔL_{C, D2} + |
| DIMM1 | ΔL_{DD} | ΔL_{DD} | ΔL_{DD} | ΔL_{DD} |
| l₁ | | | | |
| CPU to | l₀ = ΔL_{C, D2} + | l₀ = ΔL_{C, D2} + | l₀ = ΔL_{C, D2} + | l₀ = ΔL_{C, D2} + |
| DIMM0 | 2ΔL_{DD} | 2ΔL_{DD} | 2ΔL_{DD} | 2ΔL_{DD} |
| l₀ | | | | |

Table 3 illustrates a comparison of the PCB routing densities of three different “+” junction topologies (showed in FIGS. 5-7) and a 2-junction topology. In Table 3, C₀ refers to the PCB routing density under DIMM0, C₁ refers to the PCB routing density under DIMM1, and C₂ refers to the PCB routing density under DIMM2. In comparison, the routing densities under DIMM1 and DIMM0 are normalized to the routing density under the DIMM2 of a 2-junction topology. For the 2-junction topology, the highest routing density is 1 at DIMM1 and DIMM2. For the “+” topology of FIG. 5, the highest routing density is 1.5 at both DIMM1 and DIMM2. For the “+” topology of FIG. 6, the highest PCB routing density is 1.5 at both DIMM1 and DIMM2. For the “+” topology of FIG. 7, the highest PCB routing density is 1.5 at both DIMM2. The comparison indicates that the will increase the highest routing density from 1 to 1.5, using topologies of FIGS. 5-7.

TABLE 3
Comparison of routing densities for three topologies
with different locations of “+” junction
3 (FIGS. 5-7) and a 2-junction topology.

| PCB | | | FIG. 6 | |
|---|---|---|---|---|
| routing | | FIG. 5 | between DIMM2 | FIG. 7 |
| density | Original | at DIMM2 | and DIMM1 | at DIMM1 |
| DIMM2 | X1 | X1.5 | X1.5 | X1.5 |
| C₂ | | | | |
| DIMM1 | X1 | X1.5 | X1.5 | X1.5 |
| C₁ | | | | |
| DIMM0 | X0.5 | X0.5 | X0.5 | X0.5 |
| C₀ | | | | |

Note that in one embodiment the three topologies of FIGS. 5-7 need 2 layers of PCB routing. Also for the topologies of FIGS. 5-7, a microstrip can be used as a second layer, and its use won't impact the actual layer count. Thus, the topologies of FIGS. 5-7 are suited for multiple channel application.

Topologies with Staggered Vias

In one embodiment, the interconnect routing used for a channel includes staggered transition vias. One embodiment of this arrangement is shown in block diagram form in FIG. 1B . . . . For a simple 3 DIMM topology but not limited this topology may be referred to as a hybrid T (T+a daisy chain). Such an interconnect routing mitigates crosstalk and return loss. In one embodiment, this topology is applied to DDR4. However, the techniques described herein are applicable to any daisy chain interconnect topology with greater that two nodes or slots.

FIG. 8 illustrates one implementation of the interconnect topology in FIG. 1A. Such an interconnect topology is typically used for DDR. Referring to FIG. 8, vias 802-804 are a portion of the interconnect topology. Each of the DIMMs 110-112 is connected to one of vias 804, 803, and 802, respectively. In one embodiment, DIMMs 110-112 is connected to a through-hole connector with via 804, 803, and 802. Each of vias 802-804 is connected together with an interconnect portion, such as interconnect portions 806 and 807. CPU 101 is connected to via 801 using the through-hole connector. Via 801 is connected to via 802 using a stripline or microstrip interconnect 805.

The interconnect topology of FIG. 8 has some problems. First, it has poor eye margin performance of DIMM 2 due to a combination of radial coupling by multiple aggressor transition via, reflection due to the parallel impedance of DIMM 1 and DIMM 0 towards DIMM 2, multiple order reflection along the transition via to DIMM2 and length of via stub.

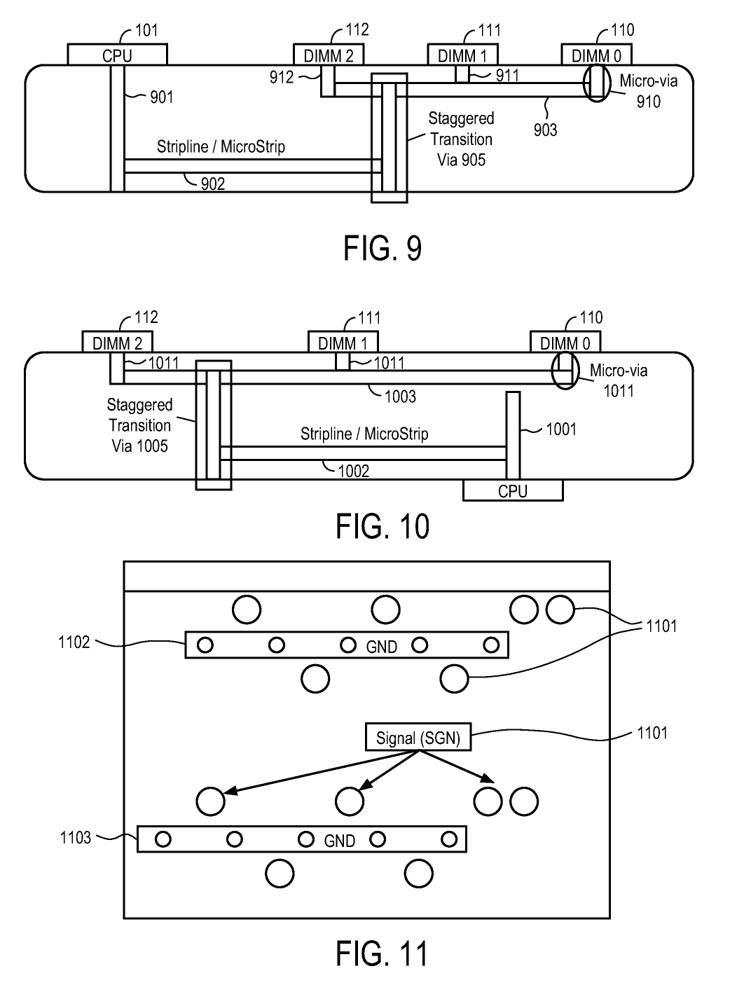

In order to mitigate some of the limiting factors, a hybrid T topology with staggered transition vias as illustrated in FIG. 9, which corresponds to the block diagram in FIG. 1B may be used.

Referring to FIG. 9, micro-vias 910-912 are connected to DIMMs 110-112, respectively, and interconnect portion 903. While only three DIMMs are shown, the computing system may have a different number of DIMMs. In one embodiment, DIMMs 110-112 are connected to micro-vias 910-912 using a surface mount connector, respectively. Each of micro-vias 910-912 is connected together with an interconnect portion 903. A staggered transition via 1005 is connected to interconnect portion 903 at a location that is between two of the DIMMs, namely between DIMM1 and DIMM2 (and not directly below one of the DIMMs). In one embodiment, the location is in the middle of DIMM1 and DIMM2 (i.e., at the 50% location between DIMM1 and DIMM2). Note that the location may be at other points on interconnect portion 903 as long as it isn't within 20% of the distance of either DIMM1 and DIMM 2 (i.e., at a location within 20% to 80% of the distance from DIMM2 in relation to DIMM1). This reduces the impact of multiple order reflections originating from the transition via impedance mismatch and via stubs on DIMM2 eye margins.

CPU 101 is connected to the circuit board on the same side as DIMMs 110-112. CPU 101 is connected to via 901 in the circuit board using a surface mount connector. Via 901 is connected to staggered transition via 905 via an interconnect portion 902. In one embodiment, the interconnect portion 902 comprises a stripline or microstrip.

FIG. 10 is another alternative embodiment of an interconnect topology. Referring to FIG. 10, which also corresponds with the block diagram in FIG. 1B, CPU 101 is connected to the circuit board on the side opposite that of DIMMs 110-112. Also, CPU is connected to via 1001, which does not traverse the entire circuit board, via a surface mount connector. Via 1001 is connected to staggered transition via 1005 via an interconnect portion 1002. In one embodiment, the interconnect portion comprises a stripline or microstrip.

Note that in alternative embodiments, the CPU and DIMMs are connected to their respective vias and micro-vias using connectors other than surface mount connectors.

FIG. 11 illustrates one embodiment of a nibble of a staggered via configuration. Referring to FIG. 11, the signals 1101 are shown divided on both sides are ground vias in 1102 and 1103.

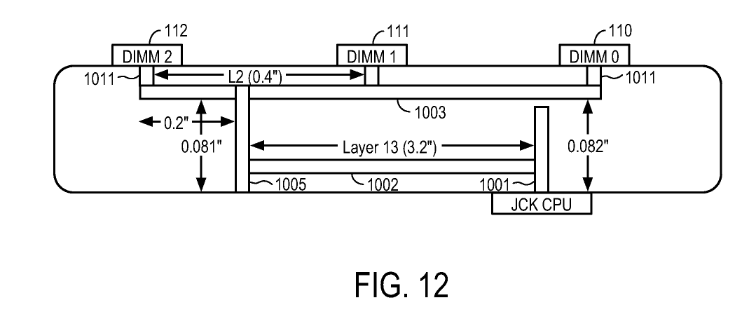

FIG. 12 illustrates the lengths for the interconnect portions of the interconnect topology shown in FIG. 10 according to one embodiment.

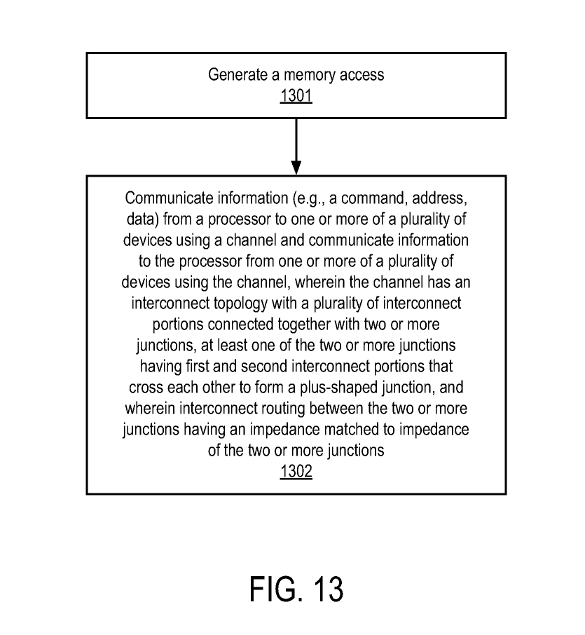

FIG. 13 is a dataflow diagram of one embodiment of a process for employing an interconnect topology described herein. Referring to FIG. 13, the process begins by processing logic generating a memory access (processing block 1301). In response to the generation of the memory access, processing logic communicates information (e.g., a command, address, data) from a processor to one or more of a plurality of devices using a channel and communicates information to the processor from one or more of a plurality of devices using the channel, wherein the channel has an interconnect topology with a plurality of interconnect portions connected together with two or more junctions, at least one of the two or more junctions having first and second interconnect portions that cross each other to form a plus-shaped junction, and wherein interconnect routing between the two or more junctions having an impedance matched to impedance of the two or more junctions (processing block 1302).

### Computing System Embodiments

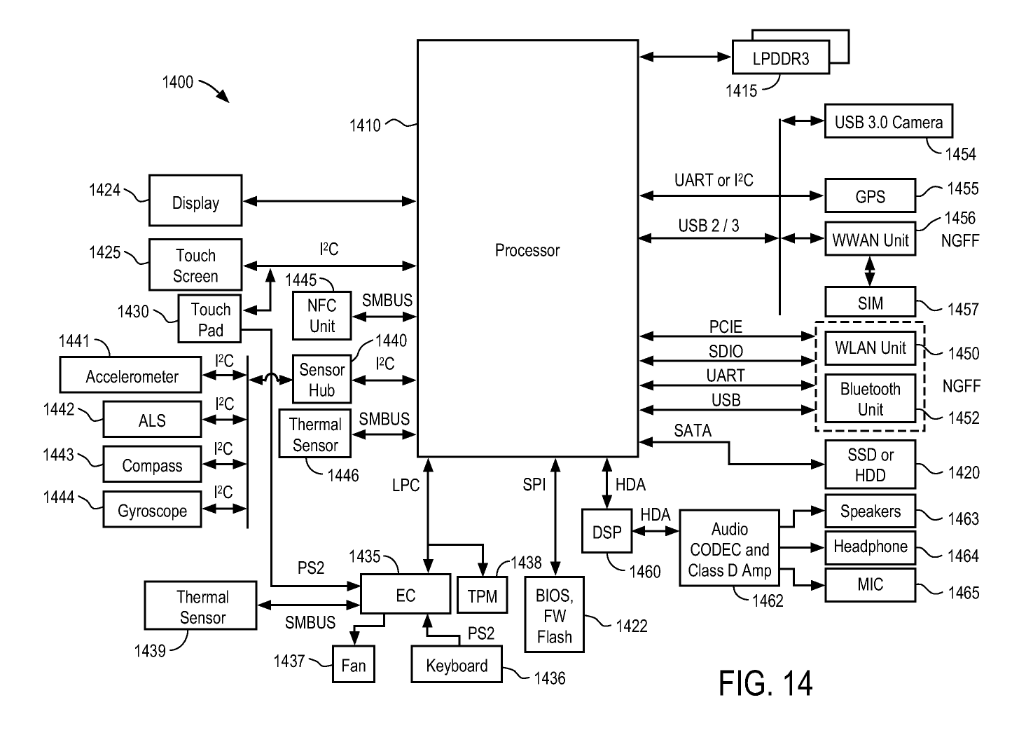

Referring to FIG. 14, an embodiment of a block diagram for a computing system including a multicore processor is depicted. Processor 1400 includes any processor or processing device, such as a microprocessor, an embedded processor, a digital signal processor (DSP), a network processor, a handheld processor, an application processor, a co-processor, a system on a chip (SOC), or other device to execute code. Processor 1400, in one embodiment, includes at least two cores—core 1401 and 1402, which may include asymmetric cores or symmetric cores (the illustrated embodiment). However, processor 1400 may include any number of processing elements that may be symmetric or asymmetric.

In one embodiment, a processing element refers to hardware or logic to support a software thread. Examples of hardware processing elements include: a thread unit, a thread slot, a thread, a process unit, a context, a context unit, a logical processor, a hardware thread, a core, and/or any other element, which is capable of holding a state for a processor, such as an execution state or architectural state. In other words, a processing element, in one embodiment, refers to any hardware capable of being independently associated with code, such as a software thread, operating system, application, or other code. A physical processor (or processor socket) typically refers to an integrated circuit, which potentially includes any number of other processing elements, such as cores or hardware threads.

A core often refers to logic located on an integrated circuit capable of maintaining an independent architectural state, wherein each independently maintained architectural state is associated with at least some dedicated execution resources. In contrast to cores, a hardware thread typically refers to any logic located on an integrated circuit capable of maintaining an independent architectural state, wherein the independently maintained architectural states share access to execution resources. As can be seen, when certain resources are shared and others are dedicated to an architectural state, the line between the nomenclature of a hardware thread and core overlaps. Yet often, a core and a hardware thread are viewed by an operating system as individual logical processors, where the operating system is able to individually schedule operations on each logical processor.

Physical processor 1400, as illustrated in FIG. 14, includes two cores—core 1401 and 1402. Here, core 1401 and 1402 are considered symmetric cores, i.e. cores with the same configurations, functional units, and/or logic. In another embodiment, core 1401 includes an out-of-order processor core, while core 1402 includes an in-order processor core. However, cores 1401 and 1402 may be individually selected from any type of core, such as a native core, a software managed core, a core adapted to execute a native Instruction Set Architecture (ISA), a core adapted to execute a translated Instruction Set Architecture (ISA), a co-designed core, or other known core. In a heterogeneous core environment (i.e. asymmetric cores), some form of translation, such a binary translation, may be utilized to schedule or execute code on one or both cores. Yet to further the discussion, the functional units illustrated in core 1401 are described in further detail below, as the units in core 1402 operate in a similar manner in the depicted embodiment.

As depicted, core 1401 includes two hardware threads 1401a and 1401b, which may also be referred to as hardware thread slots 1401a and 1401b. Therefore, software entities, such as an operating system, in one embodiment potentially view processor 1400 as four separate processors, i.e., four logical processors or processing elements capable of executing four software threads concurrently. As alluded to above, a first thread is associated with architecture state registers 1401a, a second thread is associated with architecture state registers 1401b, a third thread may be associated with architecture state registers 1402a, and a fourth thread may be associated with architecture state registers 1402b. Here, each of the architecture state registers (1401a, 1401b, 1402a, and 1402b) may be referred to as processing elements, thread slots, or thread units, as described above. As illustrated, architecture state registers 1401a are replicated in architecture state registers 1401b, so individual architecture states/contexts are capable of being stored for logical processor 1401a and logical processor 1401b. In core 1401, other smaller resources, such as instruction pointers and renaming logic in allocator and renamer block 1430 may also be replicated for threads 1401a and 1401b. Some resources, such as re-order buffers in reorder/retirement unit 1435, ILTB 1420, load/store buffers, and queues may be shared through partitioning. Other resources, such as general purpose internal registers, page-table base register(s), low-level data-cache and data-TLB 1415, execution unit(s) 1440, and portions of out-of-order unit 1435 are potentially fully shared.

Processor 1400 often includes other resources, which may be fully shared, shared through partitioning, or dedicated by/to processing elements. In FIG. 14, an embodiment of a purely exemplary processor with illustrative logical units/resources of a processor is illustrated. Note that a processor may include, or omit, any of these functional units, as well as include any other known functional units, logic, or firmware not depicted. As illustrated, core 1401 includes a simplified, representative out-of-order (OOO) processor core. But an in-order processor may be utilized in different embodiments. The OOO core includes a branch target buffer 1420 to predict branches to be executed/taken and an instruction-translation buffer (I-TLB) 1420 to store address translation entries for instructions.

Core 1401 further includes decode module 1425 coupled to fetch unit 1420 to decode fetched elements. Fetch logic, in one embodiment, includes individual sequencers associated with thread slots 1401a, 1401b, respectively. Usually core 1401 is associated with a first ISA, which defines/specifies instructions executable on processor 1400. Often machine code instructions that are part of the first ISA include a portion of the instruction (referred to as an opcode), which references/specifies an instruction or operation to be performed. Decode logic 1425 includes circuitry that recognizes these instructions from their opcodes and passes the decoded instructions on in the pipeline for processing as defined by the first ISA. For example, as discussed in more detail below decoders 1425, in one embodiment, include logic designed or adapted to recognize specific instructions, such as transactional instruction. As a result of the recognition by decoders 1425, the architecture or core 1401 takes specific, predefined actions to perform tasks associated with the appropriate instruction. It is important to note that any of the tasks, blocks, operations, and methods described herein may be performed in response to a single or multiple instructions; some of which may be new or old instructions. Note decoders 1426, in one embodiment, recognize the same ISA (or a subset thereof). Alternatively, in a heterogeneous core environment, decoders 1426 recognize a second ISA (either a subset of the first ISA or a distinct ISA).

In one example, allocator and renamer block 1430 includes an allocator to reserve resources, such as register files to store instruction processing results. However, threads 1401a and 1401b are potentially capable of out-of-order execution, where allocator and renamer block 1430 also reserves other resources, such as reorder buffers to track instruction results. Unit 1430 may also include a register renamer to rename program/instruction reference registers to other registers internal to processor 1400. Reorder/retirement unit 1435 includes components, such as the reorder buffers mentioned above, load buffers, and store buffers, to support out-of-order execution and later in-order retirement of instructions executed out-of-order.

Scheduler and execution unit(s) block 1440, in one embodiment, includes a scheduler unit to schedule instructions/operation on execution units. For example, a floating point instruction is scheduled on a port of an execution unit that has an available floating point execution unit. Register files associated with the execution units are also included to store information instruction processing results. Exemplary execution units include a floating point execution unit, an integer execution unit, a jump execution unit, a load execution unit, a store execution unit, and other known execution units.

Lower level data cache and data translation buffer (D-TLB) 1450 are coupled to execution unit(s) 1440. The data cache is to store recently used/operated on elements, such as data operands, which are potentially held in memory coherency states. The D-TLB is to store recent virtual/linear to physical address translations. As a specific example, a processor may include a page table structure to break physical memory into a plurality of virtual pages.

Here, cores 1401 and 1402 share access to higher-level or further-out cache, such as a second level cache associated with on-chip interface 1410. Note that higher-level or further-out refers to cache levels increasing or getting further way from the execution unit(s). In one embodiment, higher-level cache is a last-level data cache—last cache in the memory hierarchy on processor 1400—such as a second or third level data cache. However, higher level cache is not so limited, as it may be associated with or include an instruction cache. A trace cache—a type of instruction cache—instead may be coupled after decoder 1425 to store recently decoded traces. Here, an instruction potentially refers to a macro-instruction (i.e. a general instruction recognized by the decoders), which may decode into a number of micro-instructions (micro-operations).

In the depicted configuration, processor 1400 also includes on-chip interface module 1410. Historically, a memory controller, which is described in more detail below, has been included in a computing system external to processor 1400. In this scenario, on-chip interface 1410 is to communicate with devices external to processor 1400, such as system memory 1475, a chipset (often including a memory controller hub to connect to memory 1475 and an I/O controller hub to connect peripheral devices), a memory controller hub, a northbridge, or other integrated circuit. And in this scenario, bus 1405 may include any known interconnect, such as multi-drop bus, a point-to-point interconnect, a serial interconnect, a parallel bus, a coherent (e.g. cache coherent) bus, a layered protocol architecture, a differential bus, and a GTL bus.

Memory 1475 may be dedicated to processor 1400 or shared with other devices in a system. Common examples of types of memory 1475 include DRAM, SRAM, non-volatile memory (NV memory), and other known storage devices. In one embodiment, the memory channel to interface the memory to the remainder of the computing system includes an interconnect topology described above. As discussed above, the memory can be in accordance with a Joint Electron Devices Engineering Council (JEDEC) low power double data rate (LPDDR)-based design such as the LPDDR standards being referred to as LPDDR3 or LPDDR4. In various implementations the individual memory devices may be of different package types such as single die package (SDP), dual die package (DDP) or quad die package (Q17P). These devices, in some embodiments, are directly soldered onto a motherboard to provide a lower profile solution. In a particular illustrative embodiment, memory is sized between 2 GB and 16 GB, and may be configured as a DDR3LM package or an LPDDR2 or LPDDR3 memory that is soldered onto a motherboard via a ball grid array (BGA). In one embodiment, the memory channel comprises an interconnect topology described above.

Note that device 1480 may include a graphic accelerator, processor or card coupled to a memory controller hub, data storage coupled to an I/O controller hub, a wireless transceiver, a flash device, an audio controller, a network controller, or other known device.

Recently however, as more logic and devices are being integrated on a single die, such as SOC, each of these devices may be incorporated on processor 1400. For example in one embodiment, a memory controller hub is on the same package and/or die with processor 1400. Here, a portion of the core (an on-core portion) 1410 includes one or more controller(s) for interfacing with other devices such as memory 1475 or a graphics device 1480. The configuration including an interconnect and controllers for interfacing with such devices is often referred to as an on-core (or un-core configuration). As an example, on-chip interface 1410 includes a ring interconnect for on-chip communication and a high-speed serial point-to-point link 1405 for off-chip communication. Yet, in the SOC environment, even more devices, such as the network interface, co-processors, memory 1475, graphics processor 1480, and any other known computer devices/interface may be integrated on a single die or integrated circuit to provide small form factor with high functionality and low power consumption.

One interconnect fabric architecture includes the Peripheral Component Interconnect (PCI) Express (PCIe) architecture. The more recent versions of PCI Express take advantage of advances in point-to-point interconnects, Switch-based technology, and packetized protocol to deliver new levels of performance and features. Power Management, Quality Of Service (QoS), Hot-Plug/Hot-Swap support, Data Integrity, and Error Handling are among some of the advanced features supported by PCI Express.

In some embodiments, a system comprising: a processor; a plurality of devices; and a channel coupling the processor to the plurality of devices, the channel having an interconnect topology with a plurality of interconnect portions coupled together with two or more junctions, at least one of the two or more junctions having first and second interconnect portions that cross each other to form a plus-shaped junction, and wherein interconnect routing between the two or more junctions having an impedance matched to impedance of the two or more junctions. In some embodiments, the channel comprises a memory channel with multiple slots for interfacing to DDR memory devices.

In some embodiments, the first and second interconnect portions of the plus-shaped junction of the interconnect topology of a channel are perpendicular to each other.

In some embodiments, the first interconnect portion of the plus-shaped junction of the interconnect topology of a channel is connected to a third interconnect portion at a slot for one of the devices. In some embodiments, the one device is closest in the channel to the processor. In some embodiments, the devices comprises three devices and the one device is between two of the three devices.

In some embodiments, the plus-shaped junction of the interconnect topology of a channel is located between two of the plurality of devices closest in the channel to the processor.

In some embodiments, the routing length of an interconnect routing between two junctions of the two or more junctions is set based on resonance frequency of the interconnect routing between the two junctions, effective relative permittivity of the interconnect routing, and electromagnetic wave speed.

In some embodiments, interconnect routing between the two or more junctions has an impedance matched to impedance of the two or more junctions by at least one of: increasing routing width of the interconnect routing; reducing routing dielectric thickness of the interconnect routing; and increasing routing dielectric constant of the interconnect routing.

In some embodiments, the topology includes a staggered transition via in which a first interconnect portion connecting a second interconnect portion, which is connected to the processor, to a third interconnect portion, which is connected to a first set of devices, is connected at a location at the second interconnect portion away from being directly below any of the first set of devices. In some embodiments, the first interconnect portion of the staggered transition via is connected to the second interconnect portion at a location between two devices in the first set of devices. In some embodiments, the second interconnect portion is coupled to one or more to a first set of devices via micro-vias. In some embodiments, the first set of devices comprises a plurality of DIMMs. In some embodiments, the third interconnect comprises a stripline or microstrip.

In some embodiments, a channel for using in providing communication between a processor and a plurality of devices, includes an interconnect topology with a plurality of interconnect portions coupled together with two or more junctions, at least one of the two or more junctions having first and second interconnect portions that cross each other to form a plus-shaped junction, and wherein interconnect routing between the two or more junctions having an impedance matched to impedance of the two or more junctions.

In some embodiments, the first and second interconnect portions of the plus-shaped junction of the interconnect topology of the channel are perpendicular to each other. In some embodiments, the first interconnect portion of the plus-shaped junction is connected to a third interconnect portion at a slot for one of the devices, and wherein the one device is closest in the channel to the processor or is between two of three devices. In some embodiments, the plus-shaped junction is located between two of the plurality of devices closest in the channel to the processor. In some embodiments, the interconnect routing between the two or more junctions has an impedance matched to impedance of the two or more junctions by at least one of: increasing routing width of the interconnect routing; reducing routing dielectric thickness of the interconnect routing; and increasing routing dielectric constant of the interconnect routing.

In some embodiments, the topology of the channel includes a staggered transition via in which a first interconnect portion connecting a second interconnect portion, which is connected to the processor, to a third interconnect portion, which is connected to a first set of devices, is connected at a location at the second interconnect portion away from being directly below any of the first set of devices. In some embodiments, the first interconnect portion of the staggered transition via is connected to the second interconnect portion at a location between two devices in the first set of devices.

In some embodiments, a method for reducing multiple reflections between junctions in a channel having an interconnect topology includes: communicating information from a processor and one or more of a plurality of devices using a channel; and communicating information to the processor from one or more of a plurality of devices using the channel, wherein the channel has an interconnect topology with a plurality of interconnect portions coupled together with two or more junctions, at least one of the two or more junctions having first and second interconnect portions that cross each other to form a plus-shaped junction, and wherein interconnect routing between the two or more junctions having an impedance matched to impedance of the two or more junctions. In some embodiments, the first and second interconnect portions of the plus-shaped junction of the interconnect topology are perpendicular to each other.

In some embodiments, the first interconnect portion of the plus-shaped junction is connected to a third interconnect portion at a slot for one of the devices, and the one device is closest in the channel to the processor, is between two of three devices, or is located between two of the devices closest in the channel to the processor.

In some embodiments, the topology includes a staggered transition via in which a first interconnect portion connecting a second interconnect portion, which is connected to the processor, to a third interconnect portion, which is connected to a first set of devices, is connected at a location at the second interconnect portion away from being directly below any of the first set of devices.

Use of the phrase ‘to’ or ‘configured to,’ in one embodiment, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘capable of/to,’ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the invention as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

We claim:

1. A system comprising:
a processor;
a plurality of devices; and
a channel coupling the processor to the plurality of devices, the channel having an interconnect topology with a plurality of interconnect portions coupled together with two or more junctions, at least one of the two or more junctions having first and second interconnect portions that cross each other to form a plus-shaped junction, and wherein interconnect routing between the two or more junctions having an impedance matched to impedance of the two or more junctions.

2. The system defined in claim 1 wherein first and second interconnect portions of the plus-shaped junction are perpendicular to each other.

3. The system defined in claim 1 wherein the first interconnect portion of the plus-shaped junction is connected to a third interconnect portion at a slot for one of the devices.

4. The system defined in claim 3 wherein the one device is closest in the channel to the processor.

5. The system defined in claim 3 wherein the plurality of devices comprises three devices and the one device is between two of the three devices.

6. The system defined in claim 1 wherein the plus-shaped junction is located between two of the plurality of devices closest in the channel to the processor.

7. The system defined in claim 1 wherein routing length of an interconnect routing between two junctions of the two or more junctions is set based on resonance frequency of the interconnect routing between the two junctions, effective relative permittivity of the interconnect routing, and electromagnetic wave speed.

8. The system defined in claim 1 wherein interconnect routing between the two or more junctions has an impedance matched to impedance of the two or more junctions by at least one of:
increasing routing width of the interconnect routing;
reducing routing dielectric thickness of the interconnect routing; and
increasing routing dielectric constant of the interconnect routing.

9. The system defined in claim 1 wherein the topology includes a staggered transition via in which a first interconnect portion connecting a second interconnect portion, which is connected to the processor, to a third interconnect portion, which is connected to a first set of devices, is connected at a location at the second interconnect portion away from being directly below any of the first set of devices.

10. The system defined in claim 9 wherein the first interconnect portion of the staggered transition via is connected to the second interconnect portion at a location between two devices in the first set of devices.

11. The system defined in claim 9 wherein the second interconnect portion is coupled to one or more to a first set of devices via micro-vias.

12. The system defined in claim 9 wherein the first set of devices comprises a plurality of DIMMs.

13. The system defined in claim 9 wherein the third interconnect comprises a stripline or microstrip.

14. The system defined in claim 1 wherein the channel comprises a memory channel with multiple slots for interfacing to DDR memory devices.

15. A channel for using in providing communication between a processor and a plurality of devices, the channel having an interconnect topology with a plurality of interconnect portions coupled together with two or more junctions, at least one of the two or more junctions having first and second interconnect portions that cross each other to form a plus-shaped junction, and wherein interconnect routing between the two or more junctions having an impedance matched to impedance of the two or more junctions.

16. The channel defined in claim 15 wherein first and second interconnect portions of the plus-shaped junction are perpendicular to each other.

17. The channel defined in claim 15 wherein the first interconnect portion of the plus-shaped junction is connected to a third interconnect portion at a slot for one of the devices, and wherein the one device is closest in the channel to the processor or is between two of three devices.

18. The channel defined in claim 15 wherein the plus-shaped junction is located between two of the plurality of devices closest in the channel to the processor.

19. The channel defined in claim 15 wherein interconnect routing between the two or more junctions has an impedance matched to impedance of the two or more junctions by at least one of:
increasing routing width of the interconnect routing;
reducing routing dielectric thickness of the interconnect routing; and
increasing routing dielectric constant of the interconnect routing.

20. The channel defined in claim 15 wherein the topology includes a staggered transition via in which a first interconnect portion connecting a second interconnect portion, which is connected to the processor, to a third interconnect portion, which is connected to a first set of devices, is connected at a location at the second interconnect portion away from being directly below any of the first set of devices.

21. The channel defined in claim 20 wherein the first interconnect portion of the staggered transition via is connected to the second interconnect portion at a location between two devices in the first set of devices.

22. A method to reduce multiple reflections between junctions in a channel having an interconnect topology, the method comprising:
communicating information from a processor and one or more of a plurality of devices using a channel; and
communicating information to the processor from one or more of a plurality of devices using the channel, wherein the channel has an interconnect topology with a plurality of interconnect portions coupled together with two or more junctions, at least one of the two or more junctions having first and second interconnect portions that cross each other to form a plus-shaped junction, and wherein interconnect routing between the two or more junctions having an impedance matched to impedance of the two or more junctions.

23. The method defined in claim 22 wherein first and second interconnect portions of the plus-shaped junction are perpendicular to each other.

24. The method defined in claim 22 wherein the first interconnect portion of the plus-shaped junction is connected to a third interconnect portion at a slot for one of the devices, and wherein the one device is closest in the channel to the processor, is between two of three devices, or is located between two of the plurality of devices closest in the channel to the processor.

25. The method defined in claim 22 wherein the topology includes a staggered transition via in which a first interconnect portion connecting a second interconnect portion, which is connected to the processor, to a third interconnect portion, which is connected to a first set of devices, is connected at a location at the second interconnect portion away from being directly below any of the first set of devices.
